(19) United States
(12) Patent Application Publication
(10) Pub. No.: US 2009/0210389 A1
(43) Pub. Date: Aug. 20, 2009

(54) SYSTEM TO SUPPORT STRUCTURED SEARCH OVER METADATA ON A WEB INDEX

(75) Inventors: OREN FIRESTEIN, REDMOND, WA (US); IVAN SANTA MARIA FILHO, SAMMAMISH, WA (US); UTKARSH JAIN, REDMOND, WA (US); GAURAV SAREEN, BELLEVUE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/034,449

(22) Filed: Feb. 20, 2008

(51) Int. Cl. G06F 7/06

(52) U.S. Cl. 707/3; 707/E17.014

(57) ABSTRACT

Systems, methods, and computer storage media for performing a structured search using metadata in a search index. A search index is augmented with meta words that are traditionally not found in the documents indexed. Documents to be indexed in the search index are analyzed to determine if a meta word that has a logical relationship to the document should be associated and then stored in the index along with metadata. In some embodiments the metadata is attribute metadata and document identification metadata. Query operators are then provided to aid in performing a structured search of the search index. In some embodiments s structured search request is received and parsed into nodes which is then utilized to search a search index. In some embodiments, the results of the search index are merged, duplicates removed, and sorted when presented.

### BACKGROUND

Generally, an electronic search index is a collection of data elements that have been parsed and stored from a collection of files or documents. A search index is used to locate a specific file or document that includes a searched data element. The results of an Internet oriented search of a search index has traditionally been limited to ranking the results based on relevance to the original search query.

### SUMMARY

Embodiments of the present invention relate to systems, methods, and computer storage media for performing a structured search using metadata in a search index. A search index is augmented with meta words that are traditionally not found in the documents that are indexed. Documents to be indexed in the search index are analyzed to determine if a meta word, that has a logical relationship to the document, should be associated with the document and then stored in the index along with metadata. Query operators are then provided to aid in performing a structured search of the search index.

This Summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a block diagram of an exemplary system suitable for implementing embodiments of the present invention, in accordance with an embodiment of the present invention;

FIG. 3 is a block diagram of another exemplary system suitable for implementing embodiments of the present invention, in accordance with an embodiment of the present invention;

FIG. 4 is a flow diagram of an exemplary method for performing a structured search using metadata in a search index, in accordance with an embodiment of the present invention;

FIG. 5 is a flow diagram of another exemplary method for performing a structured search using metadata in a search index, in accordance with an embodiment of the present invention;

FIG. 6 is a block diagram of an exemplary representation of a meta word as augmented in the search index, in accordance with an embodiment of the present invention;

FIG. 7 is a block diagram of an exemplary query operator, in accordance with an embodiment of the present invention; and

FIG. 8 is a flow diagram of yet another exemplary method for performing a structured search using metadata in a search index, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Embodiments of the present invention relate to systems, methods, and computer storage media for performing a structured search using metadata in a search index. A search index is augmented with meta words that are traditionally not found in the documents that are indexed. Documents to be indexed in the search index are analyzed to determine if a meta word, that has a logical relationship to the document, should be associated with the document and then stored in the index along with metadata. Query operators are then provided to aid in performing a structured search of the search index.

Accordingly, in one aspect, the present invention provides a method for performing a structured search using metadata in a search index. The method includes augmenting a search index with one or more meta words to facilitate a structured search, wherein the one or more meta words correspond to at least one attribute that is supported by the structured search. One member of the one or more meta words that has a logical relationship with a document indexed in the search index is associated with the document. The one member of the one or more meta words is encoded with metadata of the attribute that represents the logical relationship between the at least one member of the one or more meta words and the document. The method additionally includes storing the at least one member of the one or more meta words encoded with the attribute metadata in the search index, wherein the at least one member of the one or more meta words is comprised of the attribute metadata and a document identifier for the document; and providing one or more query operators that utilize the one or more meta words.

In another aspect, the present invention provides a system for a structured search over metadata. The system includes at least one computing device operable with at least one processor and at least one computer storage media; an augmenting component of the at least one computing device operable to augment a search index with meta words; an associating component of the at least one computing device operable to associate a meta word with a document indexed in the search index such that a logical relationship exists between the meta word and the document; an updating component of the at least one computing device operable to update the search index with the meta word associated with the document such that the meta word associated with the documents includes metadata of an attribute of the document; a query receiver of the at least one computing device operable to receive a structured search query; an operator generator of the at least one computing device operable to generate one or more query operators for the structured search query; a query compiler of the at least one computing device operable to compile the structured search query and the one or more query operators to form a compiled search query; a searching component of the at least one computing device operable to search the search index with the compiled search query to generate search results; and a presenter of the at least one computing device operable to present the search results.

A third aspect of the present invention provides computer storage media having computer-executable instructions embodied thereon for performing a method for performing a structured search using metadata in a search index. The method comprises supplementing a search index, to facilitate a structured search, with one or more meta words that corresponds to at least one attribute that is supported by the structured search. A document indexed in the search index is analyzed to determine if at least one member of the one or more meta words have a logical correlation with the document. The at least one member of the one or more meta words is associated with the document when a logical correlation exists. The method further includes encoding the at least one member of the one or more meta words with metadata of the attribute that represents the logical correlation between the at least one member of the one or more meta words and the document; encoding the at least one member of the one or more meta words with metadata of a document identification of the document; storing the at least one member of the one or more meta words encoded with the attribute metadata and the document identification metadata in the search index; providing one or more query operators that utilize one or more of the plurality of meta words; receiving a structured search query request; parsing the structured search query request into nodes wherein parsing of the structured search query generates a plurality of nodes such that at least one node is associated with each parsed element of the structured search query and at least one of the plurality of nodes relates to at least one member of the one or more meta words; searching the augmented search index with at least the plurality of nodes to generate a result; and presenting the result.

Having briefly described an overview of embodiments of the present invention, an exemplary operating environment suitable for implementing embodiments hereof is described below.

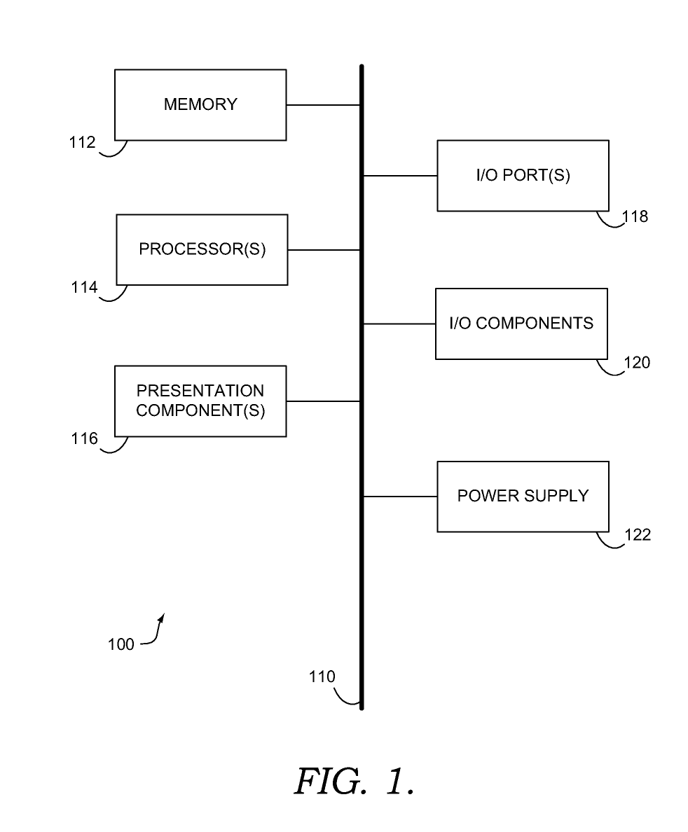

Referring to the drawings in general, and initially to FIG. 1 in particular, an exemplary operating environment suitable for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks or implements particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, and the like. I/O ports 118 allow computing device 100 to be logically coupled to other devices including I/O modules 120, some of which may be built in. Illustrative modules include a microphone, joystick, game pad, satellite dish, scanner, printer, wireless device, and the like.

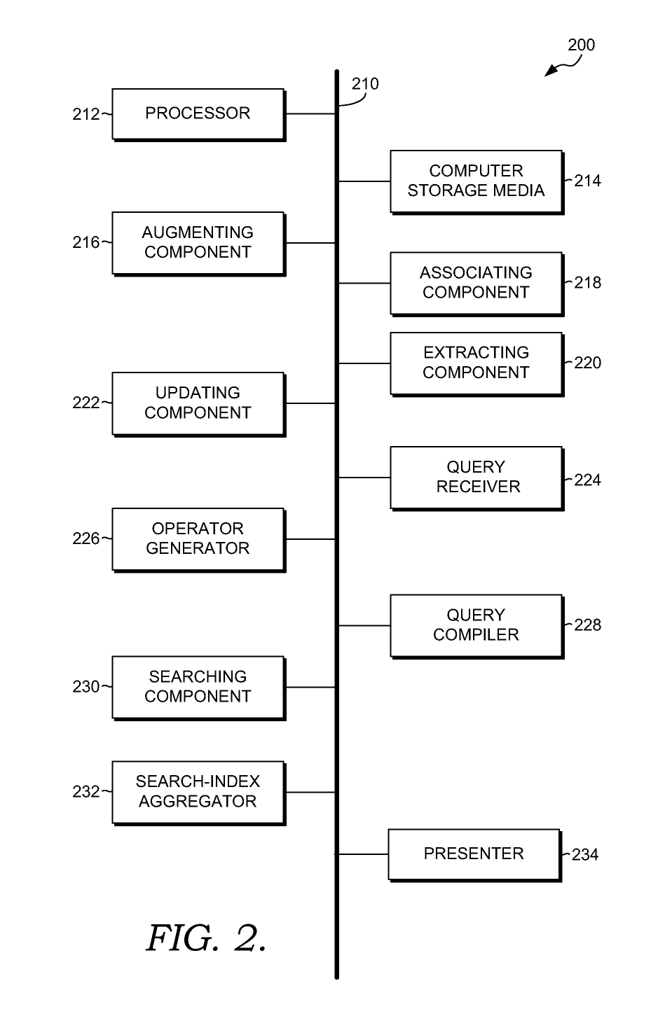

With reference to FIG. 2, a block diagram is shown that illustrates an exemplary system suitable for implementing embodiments of the present invention as shown and designated generally as structured search system 200, in accordance with an embodiment of the present invention. Structured search device 200 is but one example of a suitable operating environment and is not intended to suggest any limitations as to the scope or functionality of the invention. Neither should structured search device 200 be interpreted as having any dependency or requirement relating to any one or combination of modules/components illustrated.

Structured search device 200 includes a bus 210 that directly or indirectly couples the following components and modules: one or more processors 212, computer storage media 214, augmenting component 216, associating component 218, extracting component 220, updating component 222, query receiver 224, operator generator 226, query compiler 228, searching component 230, search index aggregator 232, and presenter 234. Bus 210 represents what may be one or more busses that are physically coupled or wirelessly coupled to the one another and the components and modules of the structured search device 200. Although the various blocks of FIG. 2 are shown with lines for the sake of clarity, in reality, delineating various components is not so clear, and metaphorically, the lines would more accurately be grey and fuzzy. For example augmenting component may include an updating component. The inventors hereof recognize that the diagram of FIG. 2 is merely illustrative of an exemplary embodiment of the structured search device.

Structured search device 200, in an exemplary embodiment, is associated with one or more computing devices such that the components and modules of structured computing device 200 are coupled or incorporated into one or more computing devices such as the computing device previously described in conjunction with FIG. 1.

With reference to augmenting component 216 which augments one or more search indexes to include one or more meta words. A search index is a collection of data that has been parsed and stored from electronic documents. Search indexes can be in the form of several data structures that include, but are not limited to, suffix tree structure, tree structure, inverted index structure, citation index structure, Ngram index structure, and term document matrix structure. The various types of search indexes have been contemplated in various embodiments of the invention. In particular, the inverted index stores a list of occurrences of each atomic search criterion, typically in the form of a hash table or a binary tree. Stated differently, an inverted index stores a list of the documents that contain each word that is indexed by the index. An inverted index allows a search query to locate documents that contain the words in a search query and then rank these documents by relevance. Therefore, an inverted index traditionally only indexes those words that are found in the documents analyzed. As a result, the augmenting component 216 augments the search index to include meta words that are not traditionally found within the source documents. As used herein, the term “document” represents any electronic data object that is capable of being indexed. Exemplary document types include, but are not limited to, html files, encrypted files, compressed files, video files, audio files, document files, data bases, tables, postscript files, XML data, and Internet accessible file types.

A meta word is not traditionally a word or data expression that is located or included within the documents indexed by a search index, but instead, a meta word represents a characteristic or element that can be located in the documents. For example, a meta word can be represented as “_MetaWordPrice”. Where _MetaWordPrice is not traditionally located or included in a document, but the meta word, _MetaWordPrice, does represent an element that is found within the document. In this example the element the meta word represents is a price characteristic located in the document. In an exemplary embodiment, augmenting component 216 augments the search index to include _MetaWordPrice as one of the elements indexed in the index.

Associating component 218 associates a meta word that has been included in the search index with a document. In an exemplary embodiment, the association between a meta word and a document creates an entry in the search index such that it appears the meta word is located within the associated document. Associating component 218 evaluates the document to determine if the document contains any characteristics that are represented by one or more of the meta words augmented in the search index. Returning to the previous example of a meta word represented as _MetaWordPrice, once the augmenting component 216 has augmented the search index to include _MetaWordPrice, associating component 218 evaluates and analyzes a document to determine if the document includes elements that are represented by the meta word _MetaWordPrice. In this example, associating component 218 determines that the document includes the price for a product, the associating component 218 then associates _MetaWordPrice with the document so that the search index indicates that meta word _MetaWordPrice is located in the document.

Once a meta word has been associated with a document, extracting component 220 extracts the underlying data or value that represents an association between the meta word and the document. For example, when _MetaWordPrice is associated with a document it is because associating component 216 determined that information or data within the document has a logical relationship with _MetaWordPrice, such as a “$10.50” included in the document. In this example the $10.50 is the attribute that is extracted from the document. The value or data of the attribute is know as the attribute metadata. The attribute metadata is information included in the context of the document as opposed to information about the document. For example, attribute metadata does not include the document's page attributes such as the document's size or date of creation. Instead, attribute metadata is information of elements included in the document such as a price value or a geographic location included in the context of the document. Attribute metadata that is extracted by extracting component 220 is then associated with the indexed meta word that resulted in the attribute metadata's extraction. Updating component 222 updates the search index with the attribute metadata that was extracted by the extracting component 220.

An inverted index contains, for each word in the index, a list of documents that contain that word. The list of documents is represented as a 64-bit document identification (ID) space where 48-bits represent a location of the document. The remaining space of the document ID can be used to store metadata associated with the document. Updating component 222 updates the document ID of a meta word with the attribute metadata extracted. If the attribute metadata extracted by the extracting component 220 will require more bit space than the remaining 16 bits available with a meta word's document ID, multiple meta words will be created to overcome the bit limitation. For example, if more than 16 bits are required to store the attribute metadata for _MetaWordPrice then _MetaWordPrice2 is augmented to the search index. The addition of _MetaWordPrice2 to _MetaWordPrice provides 32-bits of storage (16-bits in _MetaWordPrice and 16-bits in _MetaWordPrice2). Additional meta words can be created to achieve the bit space required to store the associated attribute metadata. Continuing with the example, if _MetaWordPrice and _MetaWordPrice2 are required to store the price attribute metadata, _MetaWordPrice and _MetaWordPrice2 are merged at runtime to obtain the entire attribute metadata value. In an exemplary embodiment when a certain number of meta words have been augmented to the search index in order to provide sufficient bit space for a particular attribute, that number of meta words will be used for all documents that are associated with the meta word regardless of if the other documents require the entire bit space provided by the number of meta words augmented to the search index. Using the above example, if document 1 requires _MetaWordPrice and _MetaWordPrice2 to store up to 32 bits for the price attribute metadata, but document 2 only requires the space provided by _MetaWordPrice to store its price attribute metadata, document 2 will still be associated with both _MetaWordPrice and _MetaWordPrice2 because document 1 required both of the meta words to store its price attribute metadata.

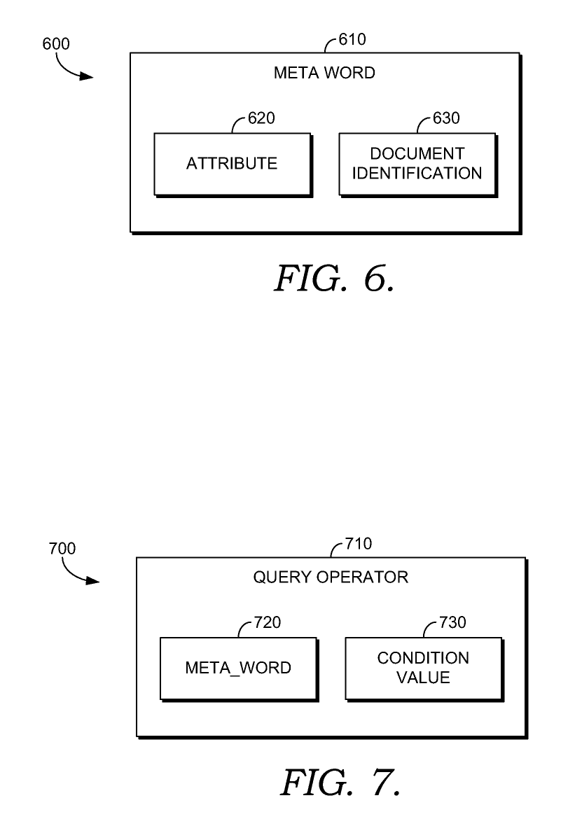

Referring to FIG. 6, a block diagram of an exemplary representation of a meta word 600 is augmented in the search index, in accordance with an embodiment of the present invention. The meta word includes the word character 610 which can be exemplified from an above example as _MetaWordPrice. Meta word 600 also includes document identification 630 and attribute metadata 620. From the above example, the meta word _MetaWordPrice includes a document identification 630 that is a unique identifier of the document and location as well as attribute metadata 620 which contain the attribute metadata such as $10.50. In an exemplary embodiment, meta word 600 is indexed in an inverted index and document identification630 and attribute metadata 620 therefore are stored on the same data structure as the inverted index. It will be understood and appreciated by those skilled in the art that the attribute metadata and document identification is not limited to separate distinct fields, instead they may be one field that can be logically interpreted.

Returning to FIG. 2, query receiver 224 receives a search query. The query is received from a user or a computing device, either one of which is attempting to query the search index. The originator of the structured search query request is the user or computing device that submitted the structured search query request. In an exemplary embodiment, the search query request includes query operators that are generated by operator generator 226. An operator generated by the operator generator 226 represents a condition to be placed on a meta word. For example, a query operator can be represented as “_MetaWordLess(“meta word”, attribute value)”. The condition imposed by this query operator if applied to the previous example of _MetaWordPrice would return search results that include the _MetaWordPrice where the associated attribute metadata is less than the attribute entered in the query operator. For example, _MetaWordLess(Price, 2050) represent the condition of Price less than $20.50. Therefore under this example a document that is associated with _MetaWordPrice and the extracted attribute metadata value was less than $20.50 would be included in the structured search query result. While the previous examples have all included price and financial attribute metadata it is appreciated and understood by those skilled in the art that a meta word can represent any data or information conveyed by a document. For example meta words represent the following, but are not limited to, author, publication, coordinates, location, price, size, color, distance, temperature, ratings, rankings, radius, elevation, pitch, tone, beat, date, and time. It is also appreciated and understood by those skilled in the art that the query operators include, but are not limited to, equal to, not equal to, greater than, less than, containing, beginning with, within, not in, and between. For example, _MetaWordWithinRadius(serverlocation, 50, UserLocation) would apply a constraint to the search results that the documents contained in the result are limited to those from a server within a 50 miles radius of a User's location.

The received search query request is parsed into a query tree of nodes. A node encapsulates a single operation that is required to execute the query. Terms and objects are parsed from the search query request to produce the nodes. For example, for a search query request for “brown football”, two nodes would initially be created where each node represents the inverted list for “brown” and “football”. A third node is also created for the “AND” of the “brown” node and the “football” node. An exemplary embodiment provides that each node is an index stream reader (“ISR”). An ISR implements a text reader that reads characters from a byte stream in a particular encoding.

In order to support a structured search a meta-constrained ISR is created for an operator provided. A meta-constrained ISR (node) is a constraint ISR (node) that applies a given constrain to an attribute metadata of a meta word. For example _MetaWordLess(Price, 2050) is compiled to create a word ISR for _MetaWordPrice which is then wrapped into a constraint ISR that checks the price attribute metadata for values less than $20.50. In a further exemplary embodiment a search query request is received that includes “brown football” with prices less than $20.50. A node or ISR will be created for “brown”, “football”, “and”, and _MetaWordPrice less than 2050. These nodes or ISRs are then sent to the searching component 230.

Searching component 230 uses the parsed search query which included meta-constrained ISRs (nodes) to search the search index. The searching component evaluates the search index to locate documents that satisfy the parsed search query. For example, if a search query request is received that includes “brown football” with prices less than $20.50, the searching component will only rank documents that satisfy all of the provided nodes. So, even if a large number of documents include “brown” and “football”, only those documents that include _MetaWordPrice will be ranked. This provides for an efficient structured search.

While the search index has been referred to as a single index, it is appreciated and understood by those skilled in the art that the search index can be a plurality of search indexes. Each of the search indexes can maintain a subset of the searched network or Internet. Therefore, the search can be performed over a plurality of search indexes my multiple computing devices. Search-index aggregator 232 aggregates the results of the plurality of computing devices and the plurality of search indexes to provide a search result. Utilizing a plurality of search indexes and computing devices provides an efficiency factor wherein each of the indexes returns a search result of a certain number of relevant results and the search-index aggregator 232 merges the results from the plurality of search indexes and de-duplicates the results to generate the search results that are presented to the user by presenter 234. The search results can be sorted and/or grouped based on characteristics of the attribute metadata. Therefore, the documents of the search index can simultaneously search by relevance ranking and a structured search.

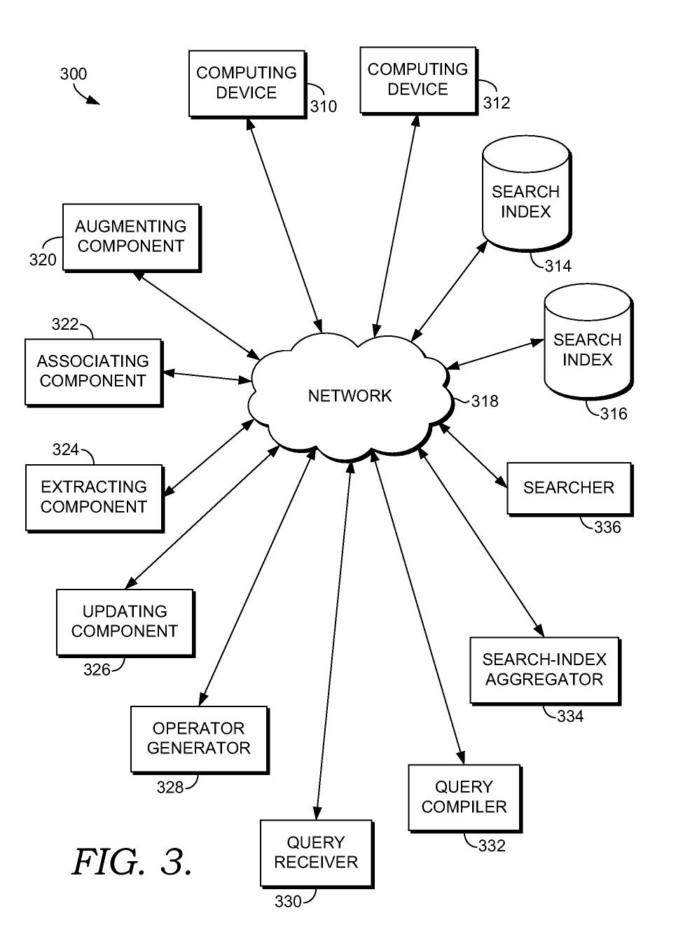

Referring now to FIG. 3, a diagram is shown that illustrates an exemplary system suitable for implementing embodiments of the present invention is shown and designated generally as structured search system 300, in accordance with an embodiment of the present invention. Structured search system 300 is comprised of: a plurality of computing devices 310 and 312, a plurality of search indexes 314 and 316, augmenting component 320, associating component 322, extracting component 324, updating component 326, operator generator 328, query receiver 330, query compiler 332, search-index aggregator 334, searcher 336, and all of the components are coupled to a network 318. Network 318 includes, without limitation, one or more local area networks (LANs) and/or wide area networks (WANs). Such networking environments are commonplace in offices, residential networks, intranets, and the Internet. Accordingly, the network 318 is not further described herein.

An embodiment of computing devices 310 and 312 was previously discussed in connection with FIG. 1. In an exemplary embodiment a user submits a search query request that is received by computing devices 310 through network 318. Computing devices 310 and 312 are also coupled through network 318 to the plurality of search indexes 314 and 316, augmenting component 320, associating component 322, extracting component 324, updating component 326, operator generator 328, query receiver 330, query compiler 332, search-index aggregator 334, and searcher 336. In another exemplary embodiment, computing device 310 is coupled to several of the components of structured search system 300 through network 318 and computing device 312 is coupled to the remaining devices of structured search system 300. It is appreciated and understood by those skilled in the art that the components of structured search system 300 can be coupled, combined, and associated in a variety of ways and the pictorial representation of FIG. 3 is merely a representation of an exemplary embodiment.

Search indexes 314 and 316 are a plurality of search indexes. Search index 314 is an index of a subset of a network such as the Internet. Search index 316 is also an index of a subset of a network. Search indexes 314 and 316 can index documents from overlapping subsets of a network and the search indexes 314 and 316 are in a data structure that facilitates a search query of the data included in the search index. In an exemplary embodiment, search indexes 314 and 316 are inverted indexes. An inverted index, as previously described, is an index data structure that stores a mapping for content, such as words or numbers, to its associated location. Embodiments of the location includes the location of a document, the location of the content within a document, and/or a document specific reference that further identifies a document.

An embodiment of the plurality of search indexes 314 and 316, augmenting component 320, associating component 322, extracting component 324, updating component 326, operator generator 328, query receiver 330, query compiler 332, search-index aggregator 334, and searcher 336 were discussed with reference to FIG. 2.

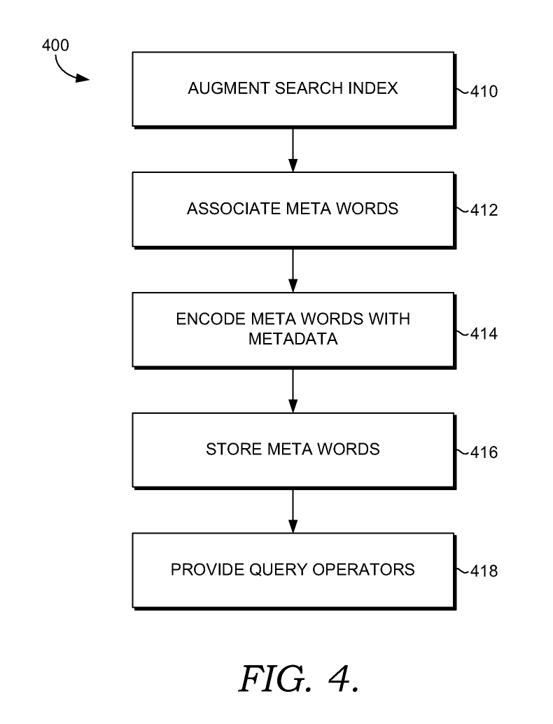

Referring now to FIG. 4, a flow diagram is shown that illustrates an exemplary method 400 for performing a structured search using metadata in a search index, in accordance with an embodiment of the present invention. Initially, as indicated at block 410, one or more search indexes are augmented with one or more meta words. The meta words that augment the search index are meta words that allow for a structured search over metadata. The search indexes are augmented because traditionally, a search index only contains the data elements found within a document, the meta words that are augmented provide context to data element found within the document, therefore the search index does not contain the augmented meta word unless the meta word is augmented to the search index.

Documents are then associated, as indicated at block 412, with meta words that have been augment to the search index. The association of a document to a meta word is performed when there is a logical relationship between the meta word and an attribute of the document. For example, the meta word _MetaWordPrice has a logical relationship to an html document accessible through the Internet that includes the text “brown football for sale . . . $20.50”. The logical relationship is that a price attribute is included in the content of the document and an attribute is price with an associated value of $20.50. Another example of a logical relationship is when a meta word such as _MetaWordCoordinates is associated with a map file that contains a longitude and latitude location.

The attribute metadata related to the attribute of the document that formed the logical relationship between the meta word and the document is then encoded in the meta word, as illustrated at block 414. For example, if the meta word _MetaWordPrice is associated with the document that includes the text “brown football for sale . . . $20.50” because the document includes a price attribute, the attribute metadata that is encoded in the meta word is “2050”. Continuing with this example, the encoded meta word could be represent as _MetaWordPrice(DOCID, 2050). Where DOCID is a unique location of the document and 2050 represents the $20.50 price attribute. It will be understood and appreciate that the attribute metadata can be represented in any way known to one skilled in the art and that the former example is only an exemplary embodiment and not limiting on the scope of the invention.

After the attribute metadata has been encoded in the meta word associated with the document, the meta word is stored in the index with the attribute metadata, as illustrated at block 416. The storing of the meta word is the updating of the search index to reflect an instance of the meta word as associated with the document and including the attribute metadata. After storing the meta word with the attribute metadata the search index contains a record that identifies a specific document that has a logical relationship to the meta word and the record also contains attribute data that can be used in a structured search.

Query operators are provided, as illustrated at block 418. The query operators provide a syntax to utilize the meta words that have augmented the search index. An exemplary textual representation of a query operator includes _MetaWordLess( ) where the operator provides for a constraint where the attribute metadata encoded with a meta word must be less than a condition value. For example, _MetaWordLess(“price”, 2100) provides search results that include the meta word _MetaWordPrice and encoded attribute metadata that is less than $21.00. Referring to FIG. 7, a block diagram 700 illustrates an exemplary query operator 710, in accordance with an embodiment of the present invention. Query operator 710 allows for Meta word 720 and condition value 730 to be incorporated into query operator 710 so that the constraint of query operator 710 is applied to meta word 720 using condition value 730. In an exemplary embodiment, query operator 710 is provided to a user interface where the user selects from a plurality of meta words augmented in the search index and the user also supplies the condition value 730 to the user interface, thereinafter the user interface populates the meta word 720 and the condition value 730 into the query operator 710 in order to perform a structured search.

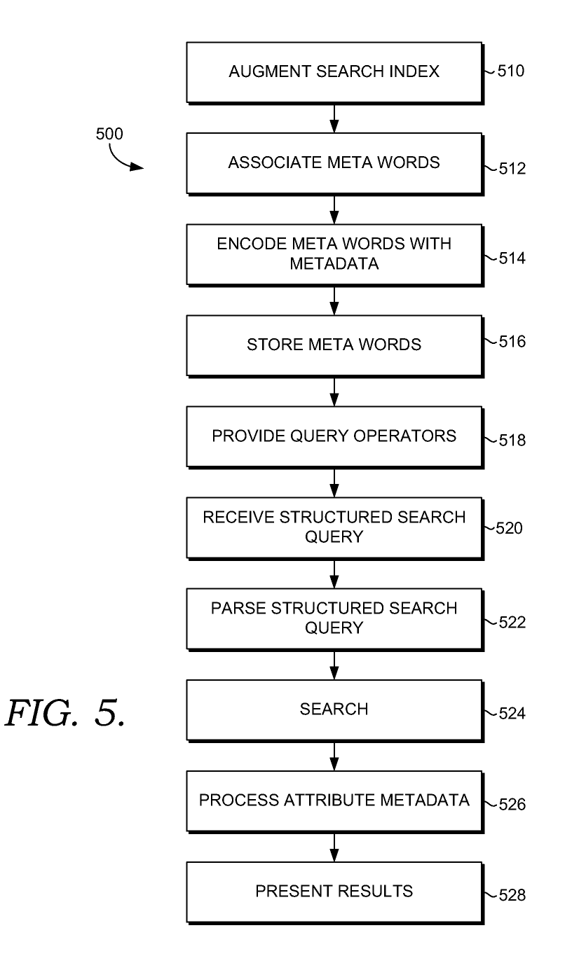

Referring to FIG. 5, a flow diagram is shown that illustrates an exemplary method 500 for performing a structured search using metadata in a search index, in accordance with an embodiment of the present invention. The method for performing the structured search includes: augmenting the search index 510, associating meta words 512, encoding meta words with metadata 514, store meta words 516, provide query operators 518, receive structured search query 520, parse structured search query 522, search, 524, process attribute metadata 526, and present results 528.

Augmenting the search index, as illustrated at block 510, augments a search index with one or more meta words that are supported by a structured search. Associating meta words, as illustrated at block 512, associates one or more meta words with one or more documents that have been included in the search index. The association of a meat word and a document is made when there is a logical relationship that exists between the meta word and the document. Encoding the meta word that has been augmented into the search index with the metadata of an attribute, as illustrated at block 514, encodes the attribute metadata of an attribute of the document with the meta word. The attribute generally is the basis of the logical relationship between the meta word and the document, and the attribute metadata is the value or data associated with the attribute that will be used in the structured search. The encoding of the attribute metadata in the meta word includes encoding a particular record or entry for the meta word that represents a particular instance of the meta word in association with the document. In an embodiment, encoding meta words with metadata includes encoding a document ID for the document associated with the meta word. The encoded meta word is stored, as illustrated at block 516. Query operators are provided, as illustrated at block 518. The query operators are provided to users and searchers either directly or indirectly through user interfaces or other searching mechanisms.

A structured search query is received, as illustrated at block 520. An exemplary embodiment includes receiving a structured search query where the structured search query includes query operators. The query operators allow for a search that includes both traditional ranking as well as structured searching. After receiving the structured search query, the query is parsed into terms and objects. Each parsed term and object is a node. After the structured search query is parsed a search is performed as illustrated at block 524. The search uses the parsed elements of the structured search query request to generate results from one or more search indexes. The results are grouped and sorted according to the constraints and conditions included with the search query request. An exemplary embodiment processes the attribute metadata of the documents included in the search results to form a structured search results. For example, if a query operator included with the search query request incorporates a constraint that price is less than $21.00, then the attribute metadata of each document of the results will be processed to sort the documents that include the meta word price and the encoded attribute metadata is less than $21.00. The processing of attribute metadata is illustrated at block 526. The search results are presented to the search query request generator, as illustrated at block 528. The results can be presented in a variety of ways. In an exemplary embodiment the results are presented to a user interface that then displays the results. In an additional exemplary embodiment the results are submitted in a data form to a requester for further manipulation or storage. It is understood and appreciated by those skilled in the art that the presentation of the results can be done in many formats and the examples provided herein are not limiting on the presentation methods.

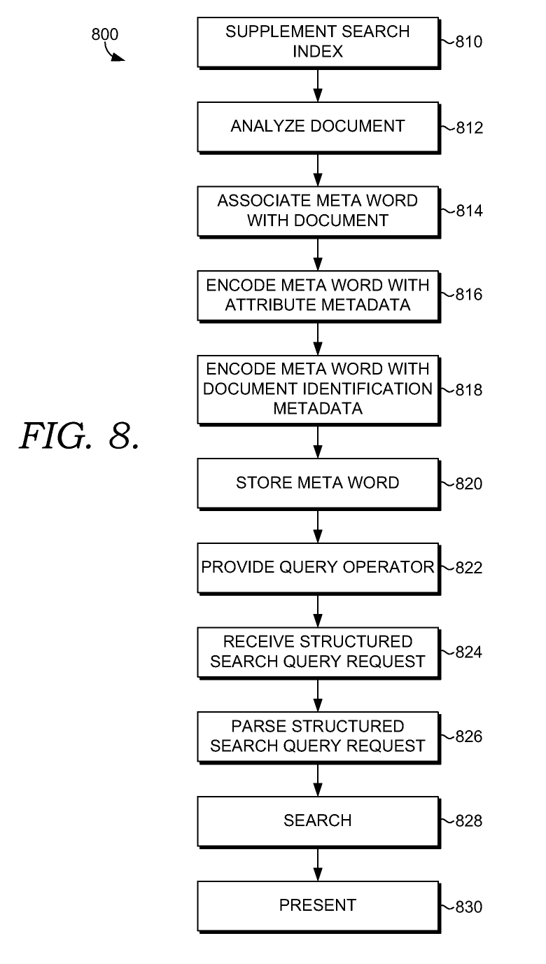

Referring to FIG. 8, a flow diagram is shown that illustrates an exemplary method 800 for performing a structured search using metadata in a search index, in accordance with an embodiment of the present invention. The method includes supplementing the search index, as illustrated at block 810. Supplementing a search index incorporate meta words, that would traditionally not included in a search index, into a search index. The incorporation of the meta words in the search index allow for document records that contain a document identification and attribute metadata to be included in the search index associated with the supplemented meta words. The method continues, documents that are indexed in the search index are analyzed to determine which meta words should be associated with the document. The analysis of the document is illustrated at block 812. A document is analyzed to determine if a meta word, which is not included in the document, should be indexed as being associated with the document for purposes of supporting a structured search. Once the document has been analyzed, and it has been determined that at least one meta word is appropriate to associate with the document, the meta word is associate with the document, as illustrated at block 814. The association is based on a logical relationship that is found between the meta word and the document. In an exemplary embodiment, the association of a document and a meta word is represented by creating a record in the search index that indicates that the meta word is located in the document.

After associating a meta word with a document, the attribute metadata of the attribute is encoded in the meta word, as illustrated at block 816. In an exemplary embodiment, the attribute meta data is encoded into a record of the search index that is associated with the meta word. For example, if the search index is an inverted index and the meta word _MetaWordPrice is one of the terms indexed, then a record is generated for each document that is associated with _MetaWordPrice. The record includes metadata that represent both the associated document's location and the attribute metadata. Therefore, not only is the attribute metadata encoded in the meta word, but the document's identification is also encoded in the meta word, as illustrated at block 818. The document's identification may include the document's location, a unique reference to the document, or even information about where in a document the meta word is virtually located. In an exemplary embodiment, if a document with the unique reference of 123456 includes the text “Price $20.50”, after the document is analyzed it is determined that a logical relationship exists between _MetaWordPrice and the document. The meta word would be encoded such that _MetaWordPrice is found in document 123456 with attribute metadata of 2050. Once encoded, the meta word is stored, as illustrated at block 820. The storing of the meta word is done in an exemplary embodiment by generating a record in the search index that indicate that the meta word is found in a particular document, which is identified by the encoded document identification metadata, and the attribute metadata of that document is included in the record.

Query operators are provided as illustrated at block 822. A structured search query request is received, as illustrated at block 824. The received structured search query is parsed into nodes, as illustrated at block 826. A search of the one or more search index is performed utilizing the parsed search query request, as illustrated at block 828. The search generates results that satisfy the parsed search query. The results may have been generated my multiple searchers over multiple search indexes therefore, the results are merged and de-duplicated to remove duplicate entries. An advantage of multiple searchers and/or multiple indexes is that the results from each may be limited to a select number of results that once merged generate a complete search result, thus providing efficiency in the structured search. The results are presented, as illustrated at block 830. The presentation of the results may include sorting, grouping or further constraining the results based on the attribute metadata of each document. An example of sorting the results fro presentation includes generating a histogram of the results or determining an average value of the attribute metadata associated with a particular meta word. It will be understood and appreciate by those skilled in the art that various grouping and sorting techniques are well known in the art

What is claimed is:

1. A method for performing a structured search using metadata in a search index, the method comprising:
augmenting a search index with one or more meta words to facilitate a structured search, wherein the one or more meta words correspond to at least one attribute that is supported by the structured search;
associating at least one member of the one or more meta words with a document indexed in the search index wherein the at least one member of the one or more meta words have a logical relationship with the document;
encoding the at least one member of the one or more meta words with metadata of the attribute that represents the logical relationship between the at least one member of the one or more meta words and the document;
storing the at least one member of the one or more meta words encoded with the metadata of the attribute in the search index, wherein the at least one member of the one or more meta words is comprised of the metadata of the attribute and a document identifier; and
providing one or more query operators that utilize the one or more meta words.

2. The method of claim 1, further comprising receiving a structured search query request.

3. The method of claim 2, further comprising parsing structured search query request, wherein the parsing of the structured search query generates a plurality of nodes such that at least one node is associated with each parsed element of the structured search query.

4. The method of claim 3, further comprising searching the augmented search index with at least the plurality of nodes to generate a result containing the at least one member of the one or more meta words.

5. The method of claim 4, further comprising processing the metadata of the attribute of the meta words contained in the generated search results

6. The method of claim 5, further comprising presenting the result to an originator of the structured search query request.

7. The method of claim 6, wherein the result is sorted according to the metadata of the attribute of the meta words.

8. The method of claim 6, wherein the result is presented as a histogram.

9. The method of claim 4, further comprising aggregating search results from a plurality of search indexes.

10. The method of claim 3, wherein each of the plurality of nodes is an index-stream reader (ISR).

11. The method of claim 10, further comprising generating at least one meta-constrained ISR for at least one meta word searched in the structured search query.

12. The method of claim 11, wherein the meta-constrained ISR applies a constraint to the at least one meta word that the meta-constrained ISR was generated for.

13. A system for a structured search over metadata, the system comprising:
at least one computing device operable with at least one processor and at least one computer storage media;
an augmenting component of the at least one computing device operable to augment a search index with meta words;
an associating component of the at least one computing device operable to associate a meta word with a document indexed in the search index such that a logical relationship exists between the meta word and the document;
an updating component of the at least one computing device operable to update the search index with the meta word associated with the document such that the meta word associated with the document includes metadata of an attribute of the document;
a query receiver of the at least one computing device operable to receive a structured search query;
an operator generator of the at least one computing device operable to generate one or more query operators for the structured search query;
a query compiler of the at least one computing device operable to compile the structured search query and the one or more query operators to form a compiled search query;
a searching component of the at least one computing device operable to search the search index with the compiled search query to generate search results; and
a presenter of the at least one computing device operable to present the search results.

14. The system of claim 13, wherein the associating component analyzes the document to determine which of a plurality of meta words have a logical relationship with the document.

15. The system of claim 14, wherein the associating component extracts the metadata of the document.

16. The system of claim 13, further comprising an extracting component of the at least one computing device operable to extract, from the document, metadata of a one or more attributes that have a logical relationship with at least one meta word supported by the structured search.

17. The system of claim 13, wherein the updating component updates the search index with the meta word associated with the document and the metadata of the attribute.

18. The system of claim 13, further comprising a search-index aggregator of the at least one computing device operable to aggregate multiple search indexes to be searched by the searcher.

19. The system of claim 18, wherein the search-index aggregator removes duplicate records from the aggregated multiple search indexes.

20. One or more computer storage media having computer-executable instructions embodied thereon for performing a method for performing a structured search using metadata in a search index, the method comprising:
supplementing a search index with one or more meta words to facilitate a structured search, wherein the one or more meta words correspond to at least one attribute that is supported by the structured search;
analyzing a document indexed in the search index to determine if at least one member of the one or more meta words have a logical correlation with the document;
associating the at least one member of the one or more meta words with the document when a logical correlation exists;
encoding the at least one member of the one or more meta words with metadata of the attribute that represents the logical correlation between the at least one member of the one or more meta words and the document;
encoding the at least one member of the one or more meta words with metadata of a document identification of the document;
storing the at least one member of the one or more meta words encoded with the metadata of the attribute and the document identification metadata in the search index;
providing one or more query operators that utilize the one or more meta words;
receiving a structured search query request;
parsing the structured search query request into nodes wherein parsing of the structured search query generates a plurality of nodes such that at least one node is associated with each parsed element of the structured search query and at least one of the plurality of nodes relates to at least one member of the one or more meta words;
searching the augmented search index with at least the plurality of nodes to generate a result; and
presenting the result to an originator of the structured search query request.
